(19) United States
(12) Patent Application Publication
(10) Pub. No.: US 2023/0169163 A1
(43) Pub. Date: Jun. 1, 2023

(54) SOFTWARE ISOLATION USING EVENT DRIVEN MULTI-THREADING

(71) Applicant: NXP B.V., Eindhoven (NL)

(72) Inventors: Michael Andrew Fischer, San Antonio, TX (US); Roderick Lee Dorris, Dripping Springs, TX (US)

(21) Appl. No.: 17/456,738

(22) Filed: Nov. 29, 2021

(51) Int. Cl. G06F 21/54; G06F 21/55; G06F 9/48; G06F 9/30

(52) U.S. Cl. CPC G06F 21/54; G06F 21/554; G06F 9/4812; G06F 9/3009; G06F 9/30101

(57) ABSTRACT

An enhanced security of multiple software processes executing on a computer system is provided by isolating those processes from each other and from access to system hardware resources. Embodiments provide such isolation by executing kernel software that manages hardware and controls physical address space on a separate hardware thread (e.g., in an isolation domain) from the process threads executing application programs (e.g., in execution domains). This renders the software executing in the isolation domain safe from privilege escalation attacks and permits implementation of enforceable isolation between execution systems. A multithreaded processor having switch-on-event multithreading is used to provide software isolation and hardware-controlled handling of a subset of system services by a different hardware thread than the one requesting the service.

### BACKGROUND

### Field

This disclosure relates generally to security of information handling systems, and more specifically, to isolation between software entities executing on a singular system.

### Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Isolation between software entities running on an information handling system is increasingly important in order to eliminate, or, at least, to contain, the impact of malicious or erroneous programs. Conventional isolation techniques rely on management of virtual memory space, and, ultimately, on hardware privilege levels intended to allow supervisor software to operate in a reliable and trustworthy manner. The supervisor software uses the hardware privilege and, in systems with appropriate hardware facilities, application software and even full operating systems execute within virtual machines managed by hypervisor software that is often highly privileged. But all typical privilege-based isolation schemes can be compromised by privilege-escalation attacks, of which many are known to exist. Once such an attack compromises the operating system or a hypervisor, all assertions regarding the properties of that system's isolation, and the system's entire security model, can become invalid.

### BRIEF DESCRIPTION OF THE DRAWINGS

Embodiments of the present invention may be better understood by referencing the accompanying drawings.

FIG. 1 is a generalized illustration of an information handling system that can be used to implement embodiments of the system and method of the present invention.

FIG. 2 is a simplified block diagram illustrating an example processor configured in accordance with embodiments of the present invention.

FIG. 3 is a simplified processing timing diagram illustrating an example of a multi-thread processing flow in accordance with embodiments of the present invention.

FIG. 4 is a simplified flow diagram illustrating an example of an event handling process executed by an isolation thread in accordance with embodiments of the present invention.

The use of the same reference symbols in different drawings indicates identical items unless otherwise noted. The figures are not necessarily drawn to scale.

### DETAILED DESCRIPTION

Embodiments of the present invention provide enhanced security of multiple software processes executing on a computer system by isolating those processes from each other and from access to system hardware resources. Embodiments provide such isolation by executing kernel software that manages hardware and controls physical address space on a separate hardware thread (e.g., in an isolation domain) from the process threads executing application programs (e.g., in execution domains). This renders the software executing in the isolation domain safe from privilege escalation attacks and permits implementation of enforceable isolation between execution systems. Embodiments utilize a multithreaded processor having switch-on-event multithreading (SOEMT) to provide software isolation and hardware-controlled handling of a subset of system services by a different hardware thread than the one requesting the service.

Typical software entity isolation schemes executed on information handling systems utilize hardware privilege levels to enable supervisor software to operate reliably and in a trustworthy manner. Typically, all access to internal processor state pertaining to memory access permissions, peripheral device control and status registers, exception handling, and the like, are restricted to software executing with a sufficient privilege level. But privilege-based isolation schemes can be compromised by privilege-escalation attacks. Once such an attack compromises an operating system or a hypervisor, all assertions regarding the properties of that system's isolation and security are no longer valid.

Kernel software can be rendered safe from privilege-escalation attacks by executing the kernel software that performs system initialization, manages the hardware configuration, coordinates access to sharable peripherals, and controls the physical address space on a physically disjoint CPU, rather than within a privilege level of the CPU running the operating system and application programs. But such systems require a minimum of two CPU cores: one CPU to run the isolation domain software, and another CPU to run each execution domain.

Embodiments of the present invention use prioritized, preemptive, event-driven multithreading to permit this isolation scheme to be used on a system with a single CPU core. Under embodiments of the present invention, the isolation domain runs in a highest-priority hardware thread, while the execution domains run in lower-priority threads. Access to the lowest level of hardware controls, including management of the physical address space, is only possible from software executing in the highest-priority thread. Therefore, compromise of system software within an execution domain does not compromise isolation domain software and does not give an attacker access to memory or other resources assigned to other domains, even if the compromised system software is executing with the highest privilege level within that execution domain.

Using only a single CPU core results in a reduction in size and power consumption, which makes the isolation scheme of embodiments of the present invention more practical for use on microcontrollers. The availability of enforceable software isolation in microcontrollers enables improved robustness of connected equipment at the network edge, where microcontrollers are extremely common. Such microcontrollers are generally unable to use even limited software isolation available from a hypervisor, because they typically lack some of the hardware facilities needed to run a hypervisor.

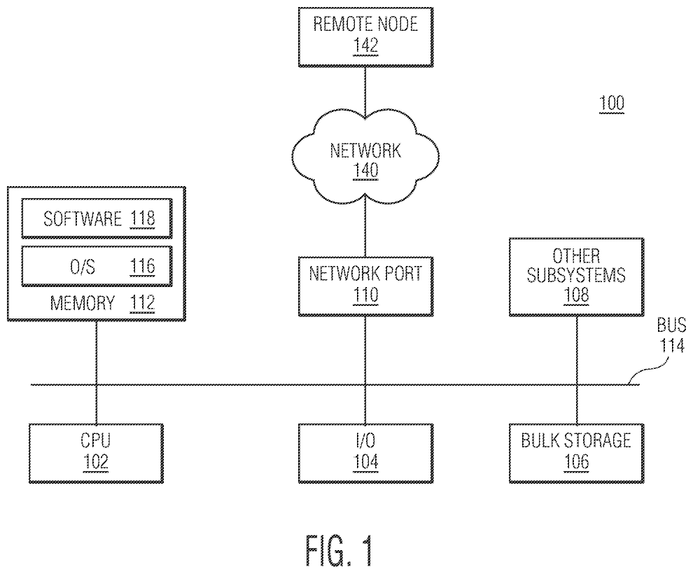

FIG. 1 is a generalized illustration of an information handling system 100 (e.g., a microcontroller) that can be used to implement embodiments of the system and method of the present invention. The information handling system 100 includes a processor (e.g., central processor unit or “CPU”) 102, input/output (I/O) devices 104, such as a display, a keyboard, a mouse, bulk storage 106, and associated controllers, and various other subsystems 108. In various embodiments, microcontroller 100 also includes a network port 110 operable to connect to a network 140, which is likewise accessible by one or more remote nodes 142 (e.g., a service provider server, a bridge, or another microcontroller). Microcontroller 100 likewise includes system memory 112, which is interconnected to the foregoing via one or more buses 114. System memory 112 can store, for example, an operating system (OS) 116 and in various embodiments may also store other software 118.

Embodiments of the present invention can be implemented using a multithreaded processor architecture. Embodiments can be provided using any instruction set architecture (ISA). Embodiments are further provided using a processor implementation that provides two or more hardware execution threads with prioritized, pre-emptive thread scheduling in response to assertion of events (e.g., switch-on event multithreading [SOEMT]). One example of such an instruction set architecture is the RISC-V ISA and extensions thereto. While RISC-V and its extensions may be used in examples below, it should be realized that embodiments are not restricted to RISC-V and can be implemented on any processor core supporting SOEMT and using any ISA.

Embodiments use certain properties of SOEMT in the disclosed software isolation scheme. In SOEMT, a CPU core supports N hardware threads, where N is greater than or equal to a total number of domains supported and is greater than or equal to two. Threads have hardware-defined priorities, with a fixed thread, referred to as thread 0, having the highest priority. Relative priorities of the other threads may be relevant to the software executing on the CPU. For example, threads executing real-time processes should have a higher priority than threads executing non-real-time processes. During each processor cycle, instructions are executed for a highest-priority, active thread. When a higher-priority thread becomes active, the executing thread is pre-empted by the higher-priority thread, and only resumes execution when all higher-priority threads are inactive. Each thread may be active or inactive, and inactive threads are activated by assertion of events assigned to that thread.

Events are physical signals that originate from either hardware or software. Events are similar to interrupt requests but with two critical differences. The first difference is that events never force asynchronous redirection of program flow. Once activated, a thread runs to completion, and subsequent event assertions are recorded, but not recognized, until the software in the thread executes a wait-for-event (WFE). If a WFE is executed when the thread has no other asserted events, that thread becomes inactive. The second difference between events and interrupt requests is that the address at which execution resumes following a WFE is controlled by software and is typically the address following the WFE instruction or another address specific to the software state when executing that particular WFE. In contrast, interrupts save the previous execution address and commence execution at a predefined interrupt vector address.

Thread 0, as the highest-priority thread, will, upon activation, pre-empt any other thread and cannot itself be pre-empted. The software isolation mechanisms discussed below take specific advantage of these two properties. Each hardware thread has a dedicated set of registers that include, at least, all architecturally-defined user mode registers of the ISA.

Unlike typical multithreaded processors, threads are not isomorphic in embodiments of the present invention. Thread 0 is the only thread having full access to the physical address space (including the full machine-mode control and status register [CSR] space in the case of a RISC-V processor). In addition, only thread 0 is active after hardware reset. Further, thread 0 is the only thread that can: (1) execute instructions that force another thread into a known state, which is used to initialize the other threads; (2) recover from catastrophic errors or software compromise within the other threads; and (3) initiate context switching by threads supporting execution domains with multiple, independent software partitions. Privilege levels available within each thread are those defined by the underlying ISA, but, even at the highest privilege level, threads other than thread 0 do not have full access to low-level CPU hardware or the full, physical address space.

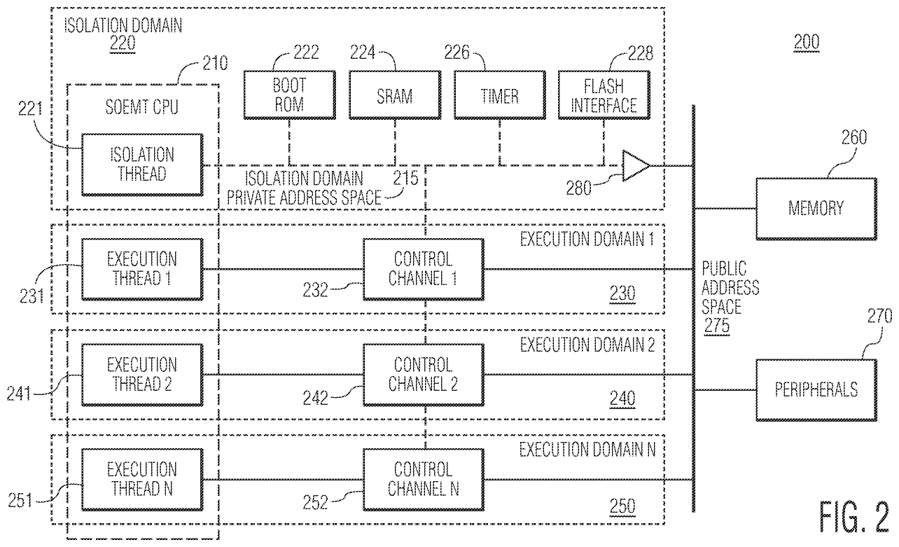

FIG. 2 is a simplified block diagram illustrating an example processor 200 configured in accordance with embodiments of the present invention. Embodiments provide that an isolation domain 220 and all execution domains (e.g., 230, 240, and 250) execute in separate threads on a single, SOEMT processor 210 (e.g. CPU 102). Private address space 215 of the isolation domain 220 is designed into the CPU hardware. The processor illustrated in FIG. 2 includes four hardware threads, but any number of hardware threads greater than or equal to two may be present.

Depending on the microarchitecture, isolation domain 220 can be implemented within the processor 210 on thread 0 (the “isolation thread” 221) using thread-aware logic within address-generation hardware, which generates an illegal address exception if a thread other than thread 0 attempts to access an address in private address space 215. Alternatively, isolation domain 220 can be implemented external to the processor core as part of the address decoding. Yet another alternative is to implement the control channels 232, 242, and 252 to map the addresses which would otherwise access the private address space 215 to access different locations, either within the public address space 275 or (if private resources are present within execution domains) internal to the respective execution domain 230, 240, or 250. If the isolation domain is implemented external to the core, the originating thread number accompanies each memory transaction as an ancillary attribute. Private address space 215 gives the isolation domain exclusive access to secure resources such as boot ROM 222, SRAM 224, timer registers 226, and a flash controller 228 (storing, for example, external firmware images). On the other hand, each of the execution domains and the isolation domain, can access the public address space 275 through their control channels, including, for example, memory 260 and peripherals 270. In this manner, the execution threads (execution threads 231, 241, 251) are not isomorphic to the isolation thread, in that they are not directly provided access to the secure hardware registers and memories within the private address space 215. The execution threads only access the secure resources through service requests to the isolation thread (e.g., thread 0). In addition, the peripherals in public address space 275 cannot access resources in private address space 215, as indicated by unidirectional interface block 280.

Each execution domain (230, 240, and 250) is coupled to isolation domain 220 via a control channel (232, 242, and 252, respectively) that is configured by the isolation domain upon initialization of the system. The execution domain threads communicate certain signals to system resources via the control channels. Control channels 232, 242, and 252 are constructed with at least an address space controller (ASC), a reset control block (RCB), and an interrupt routing block. Each of these control channels 232, 242, and 252 has control/status registers, accessible solely from the private address space 215 of the isolation domain 220, that allow software executing in the isolation thread 221 to configure access allowed by the execution thread 231, 241, or 251 associated with said control channel. The control channel management interfaces (designated by the dashed line connecting the isolation domain private address space 215 to the control channels 232, 242, and 252) are accessible solely by the isolation thread 221 via the private address space 215.

Memory bus connections from the execution domains are made through the control channel. ASC programming can assign peripherals 270 to a specific execution domain, or permit peripherals to be shared among two or more domains. Access to appropriate regions of memory and to appropriate subsets of peripherals can be through the ASC of an associated control channel. By default, the ASC blocks all outgoing access from an execution domain thread, so only those regions of memory and peripheral address space configured by the isolation thread 221 for that execution domain are accessible.

Connection from the execution domains to external interrupts is through the interrupt routing block of the control channel. If a peripheral is assigned to an execution domain, then interrupts from that peripheral block are allocated to that execution domain.

The reset control block (RCB) of the control channel establishes addresses of reset vectors and provides a control register to release a thread from a power on reset and to trigger the reset of the hardware thread for various other reset causes such as a warm reset and watchdog timer reset by the isolation thread. Each reset cause can have independent reset vector addresses, which allows the software at these vector addresses to operate independently from the software at other reset vector addresses. In addition, the vector addresses specified in the RCB cannot be overridden by software in an execution domain, even if the ISA permits privileged software to configure vector addresses.

An inter-thread event generation mechanism is used for the execution threads 231, 241, and 251 to request services from isolation thread 221. Depending on the architecture of processor 200, the inter-thread event generation mechanism can be a machine instruction that asserts a hardware event, a subset of the processor's normal system call/environment call mechanism, or a predefined programmatic interface using inter-thread flag bits that generate events to the target thread.

On a processor using RISC-V ISA, where there is a separate control and status register (CSR) address space, the CSRs pertaining to hardware configuration, clock and power management, physical address space, and the control channels only appear in the machine mode CSR space of thread 0. Other threads have only a basic set of machine mode CSRs as required to conform to the RISC-V Privileged Architecture specification. Threads other than thread 0 on a RISC-V processor can be reset from thread 0. Execution domains can support more than one software partition. If such multi-partition support is needed, the execution domain needs to support a resumable non-maskable interrupt facility, assertable from the isolation domain.

Service requests from an execution domain (e.g., execution domains 230, 240, 250) to isolation domain 220 are communicated by generating events which activate thread 0. On a RISC-V processor, for example, this can be implemented by decoding a subset of function codes of the environment call (ECALL) instruction to assert particular events to thread 0. But due to ECALL being used for system calls on RISC-V, and assignment of function codes in the RISC-V ABI standard not being yet finalized, embodiments can implement a custom service request instruction for this purpose. For use with ISAs that do not have explicit provision for custom instructions, events alternatively can be asserted by software using inter-context communication (ICC) flag bits accessed via CSRs or memory-mapped I/O, as appropriate for the relevant ISA.

In embodiments, since resource control pursuant to a system call is performed by a physically different hardware thread, privilege escalation within an execution domain cannot be used to override or circumvent proper handling of system calls. Software in any execution domain has no means to alter the privilege level of software in the isolation domain, nor the ability to access the private address space of the isolation domain. In addition, events activate thread 0 at an address controlled by thread 0 rather than via an exception vector, therefore redirection of control by malicious software that corrupts a vector table is not possible. Similarly, because the system call handler uses a return stack in private memory accessible solely within the isolation domain 220, neither is a return-oriented attack. Because SOEMT uses a run-to-completion model, with events to thread 0 recognized only after the isolation software has executed a wait-for-event (WFE), control flow in isolation domain 220 is not asynchronously redirected due to actions by software in other domains, which prevents the use of switch-on event multithreading from creating race conditions that might be exploitable. Furthermore, because thread 0 cannot be preempted, interrupts to execution threads that occur while thread 0 is active are not handled until after thread 0 executes a WFE, so interrupts initiated by execution thread activity cannot affect isolation thread execution.

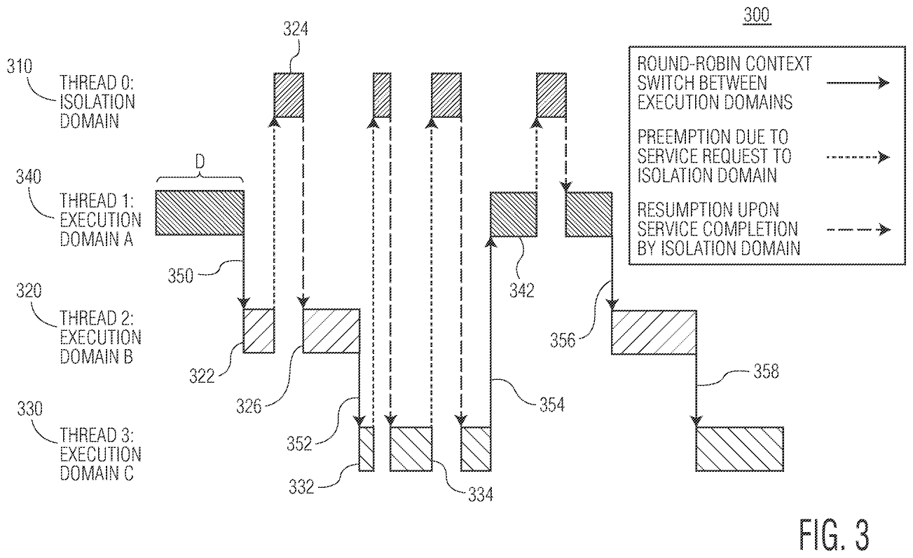

FIG. 3 is a simplified processing timing diagram illustrating an example of a multi-thread processing flow 300 in accordance with embodiments of the present invention. As discussed above, the highest-priority thread (e.g., thread 0) cannot be pre-empted, therefore functional control flow when an execution domain requests service from the isolation domain is comparable to a system call. Processing by the requester is suspended, due to pre-emption of the requesting thread by the isolation thread, until the isolation thread has completed its processing and executed its WFE. As illustrated by the dashed arrows, when a request is made to thread 0 (310), a requesting thread is suspended until control is provided back to the requesting thread. One example is when thread 2 (320) makes a service request (322) to thread 0. Processing of thread 2 is preempted (e.g. suspended) while thread 0 executes the service request (324), and then thread 2 resumes processing when the service request is completed (326). Similar functional control flow preemptions occur with thread 3 (330) (e.g., 332 and 334) and thread 1 (340) (e.g., 342).

Thread switching provides processing time for each execution domain thread if more than one execution domain is active. Embodiments are not limited to a specific method of thread switching. Threads other than thread 0 can be event-driven (thread 0 is event driven for reasons discussed above). If each execution domain runs event- or interrupt-driven software bare metal or under a real-time operating system (RTOS), this is a low-overhead approach. But if any execution domain runs a general-purpose operating system, then additional porting effort may be needed to adapt such systems to be event driven.

A more generally applicable approach is round-robin sharing of the processor. Round-robin sharing can be achieved by hardware that inactivates the current thread and activates the next execution domain thread after a set time (e.g., D microseconds), or after the current thread has executed a set number of instructions (e.g., N instructions), where the time or the number of instructions is defined and controlled by the isolation domain. An example of round-robin sharing is illustrated in FIG. 3 with the solid arrows, where round-robin context switching occurs between the various execution domains (e.g., at 350, 352, 354, 356, and 358). If round-robin thread switching is performed, that switching occurs among some or all of the non-zero threads, while thread zero remains strictly event-driven to handle service requests from lower-priority threads and hardware events related to isolation activities, peripherals in the isolation domain 220, and/or other elements of the computer system 100.

If non-uniform time division between execution domains is desirable, another time-sharing approach is to place execution domain threads fully under control of isolation domain software. When using this approach, the isolation thread software 221 is activated by hardware, such as an interval timer 226 located within the isolation domain indicating when a change of active execution domains is scheduled. The handler for this timer event changes the activity states of the execution threads using appropriate ones of its control/status registers.

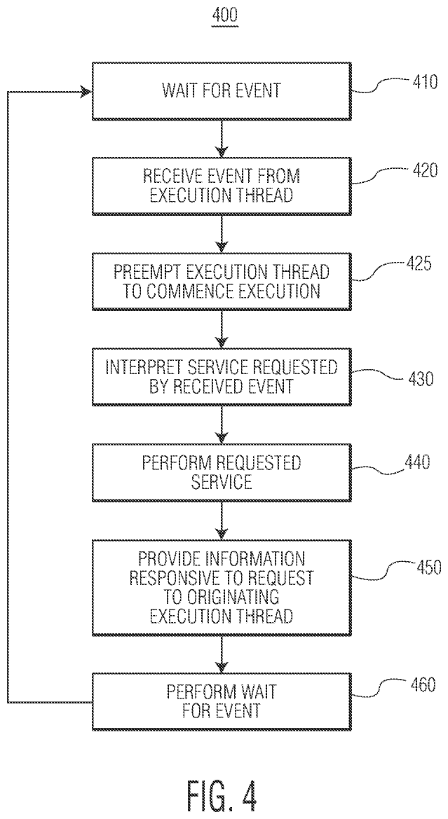

FIG. 4 is a simplified flow diagram illustrating an example of an event handling process 400 executed by an isolation thread in accordance with embodiments of the present invention. During execution of processes by the various execution threads, isolation thread (e.g., thread 0) is inactive pursuant to prior execution of a wait for event (410). When an execution thread requires a service from the isolation domain, that execution thread issues an event containing the service request to the isolation thread (e.g., at 322 of FIG. 3). The isolation thread is activated by reception of the event from the execution domain (420), thereby causing the processor hardware to preempt the execution thread and commence execution by the isolation thread (425). As the highest priority hardware thread, the isolation thread will always commence execution upon receiving an event from any other thread.

While the execution thread is preempted, the isolation thread then handles the event by interpreting the service requested by the received event (430), performing the requested service (440), and providing information responsive to the request to the originating execution thread (450). As discussed above, such a service request can include peripheral access, access to certain memory registers, changes to the settings of the execution thread's control channel, and other hardware access. Once the service request has been handled by the isolation thread, the isolation thread performs a wait for event, which inactivates the isolation thread (460). This causes the SOEMT hardware to switch the executing context back to the originating execution thread. In this manner, the execution threads are provided access to services relevant to inter-domain isolation or services requiring use of hardware that is only accessible from the isolation domain.

Embodiments of the present invention can also be implemented for use on a processor that, in addition to SOEMT, uses simultaneous multithreading (SMT). Using SMT can improve performance by issuing instructions from more than one active thread during a single clock cycle. In an SMT-based system, the instruction scheduler should be designed to ensure that at least one instruction from thread 0 is issued during any cycle when thread 0 is active and has an instruction ready for issuance. The use of SMT along with SOEMT introduces the possibility of side-channel attacks between simultaneously executing threads, and thus countermeasures should be provided against such attacks.

By now it should be appreciated that embodiments of the invention can use a SOEMT processor to implement enforceable software isolation. The highest-priority thread (e.g., thread 0) can be used to implement an isolation domain that has exclusive access to low-level hardware facilities, which includes management of physical address space, peripheral access, and interrupt routing for other threads. Inter-thread events can be used to request access to the subset of system services that are provided by the highest-priority thread.

In one embodiment, a process is configured to provide isolation of software executing in one or more execution domains, and the processor includes an isolation domain including a highest priority hardware thread executed by the processor and configured to access an entire physical address space of the processor, all control/status registers, all hardware configuration registers, and secure system resources; one or more execution domains, wherein: each execution domain includes a thread executed by the processor with a lower priority than the highest priority hardware thread of the isolation domain, each execution domain is configured to access an assigned subset of the physical address space and access an assigned subset of the control/status registers, but is unable to access any of the secure system resources, each assigned subset of the physical address space includes less than the entire physical address space, and each assigned subset of the control/status registers includes less than the entire control/status registers; and a corresponding control channel coupling each execution domain with the isolation domain, each corresponding control channel configured to provide one or more of interrupt routing, reset control, and address space control, wherein each corresponding control channel is configured exclusively by the isolation domain. In one aspect of this embodiment, the address space control of the corresponding control channel is configured to provide access to a region of memory in the physical address space to an execution domain of the one or more execution domains. In another aspect, the interrupt routing of the corresponding control channel is configured to provide a subset of external interrupts to an execution domain of the one or more execution domains. In another aspect, the corresponding control channel is configured to reset an execution domain of the one or more execution domains, without requiring reset of any other execution domains of the one or more execution domains, by applying a reset vector to the execution domain using the reset control of the corresponding control channel. In yet another aspect, the one or more execution domains are configured to communicate a service request to the isolation domain by generating an event to activate the highest priority hardware thread, and the highest priority hardware thread is configured to respond to the service request. In a further aspect, the service request includes one of an environment call (ECALL) instruction when the processor includes a RISC-V processor or a system call instruction equivalent to the ECALL instruction when the processor includes a type of processor other than a RISC-V processor. In another further aspect, the service request includes a custom service request instruction. In yet another further aspect, the service request includes one or more inter-context communication flag bits. In another aspect of the above embodiment, the isolation domain is configured to control which of the one or more execution domain threads executes by the processor. In a further aspect, the isolation domain is configured to select which of the one or more execution domain threads is executed by the processor using a round-robin context switching determined by one of a time period or a set number of instructions.

In another embodiment, a method for handling a service request in a switch-on-event multithreading (SOEMT) processor includes generating, by an execution thread operating at a first priority level, an event including the service request; receiving the event by an isolation thread operating at a second priority level, wherein the second priority level is higher than the first priority level; preempting the execution thread by the isolation thread; while the execution thread is being preempted: executing the service call by the isolation thread, and providing, by the isolation thread, information responsive to the service call to the execution thread; and after the providing the information, performing a wait for event by the isolation thread to inactivate the isolation thread. In one aspect of the another embodiment, the service request is associated with secure system resources accessible to the isolation thread and not accessible to the execution thread. In a further aspect, the secure system resources include at least one of a boot ROM, memory, timer registers, and flash memory. In another aspect of the another embodiment, the service request is associated with a request to change a subset of physical address space accessible to the execution thread. In another aspect, the service request is associated with a request to access one or more of a peripheral and an interrupt generated by the peripheral. In another aspect, the method further includes waiting for an event, by the isolation thread, prior to said receiving the event; and, in response to the receiving the event, activating the isolation thread, wherein activating the isolation thread results in preempting the execution thread. In a further aspect, the method further includes, after the isolation thread is inactivated, resuming the execution thread. In another further aspect, the activating the isolation thread includes activating the isolation thread at an address location which is only accessible by the isolation thread and is not accessible by the execution thread. In an other aspect of the another embodiment, the processor includes a RISC-V processor, and the event includes an environment call instruction.

In yet another embodiment, a system configured to provide isolation of software executing in one or more execution domains includes a processor including: an isolation domain including a highest priority hardware thread executed by the processor and configured to access the entire physical address space of the processor, access all control/status registers, all hardware configuration registers, and secure system resources, one or more execution domains, wherein each execution domain includes a thread executed by the processor with a lower priority than the highest priority hardware thread of the isolation domain, each execution domain is configured to access an assigned subset of the physical address space and access an assigned subset of the control/status registers but is unable to access any of the secure system resources, each assigned subset of the physical address space includes less than the entire physical address space, and each assigned subset of the control/status registers includes less than the entire control/status registers; and a corresponding control channel, coupling each execution domain with the isolation domain, each corresponding control channel configured to provide one or more of interrupt routing, a reset control, and an address space control, wherein each corresponding control channel is configured by the isolation domain. The system also includes a memory coupled to the processor, and a peripheral coupled to the processor, wherein the peripheral is accessible only to the isolation domain.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

The term “program,” as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system.

Some of the above embodiments, as applicable, may be implemented using a variety of different information processing systems. For example, although FIG. 1 and the discussion thereof describe an exemplary information processing architecture, this exemplary architecture is presented merely to provide a useful reference in discussing various aspects of the invention. Description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Also for example, in one embodiment, the illustrated elements of processor 200 are circuitry located on a single integrated circuit or within a same device. Alternatively, processor 200 may include any number of separate integrated circuits or separate devices interconnected with each other. For example, memory 260 may be located on a same integrated circuit as CPU 210 or on a separate integrated circuit or located within another peripheral or slave discretely separate from other elements of processor 200. Peripherals 270 may also be located on separate integrated circuits or devices.

Furthermore, those skilled in the art will recognize that boundaries between the functionality of the above-described operations merely illustrative. The functionality of multiple operations may be combined into a single operation, or the functionality of a single operation may be distributed in additional operations. Moreover, alternative embodiments may include multiple instances of a particular operation, and the order of operations may be altered in various other embodiments.

All or some of the software described herein may be received elements of processor 200, for example, from computer readable media such as memory 260 or other media on other computer systems. Such computer readable media may be permanently, removably or remotely coupled to an information processing system such as system 10. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

In one embodiment, processor 200 is part of a computer system such as an embedded microcontroller. Other embodiments may include different types of computer systems. Computer systems are information handling systems which can be designed to give independent computing power to one or more users. Computer systems may be found in many forms. A typical computer system includes at least one processing unit, associated memory and a number of input/output (I/O) devices.

A computer system processes information according to a program and produces resultant output information via I/O devices. A program is a list of instructions such as a particular application program and/or an operating system. A computer program is typically stored internally on computer readable storage medium or transmitted to the computer system via a computer readable transmission medium. A computer process typically includes an executing program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A processor configured to provide isolation of software executing in one or more execution domains, the processor comprising:
an isolation domain comprising a highest priority hardware thread executed by the processor and configured to access an entire physical address space of the processor, all control/status registers, all hardware configuration registers, and secure system resources;
one or more execution domains, wherein:
each execution domain comprises a thread executed by the processor with a lower priority than the highest priority hardware thread of the isolation domain,
each execution domain is configured to access an assigned subset of the physical address space and access an assigned subset of the control/status registers, but is unable to access any of the secure system resources,
each assigned subset of the physical address space comprises less than the entire physical address space, and
each assigned subset of the control/status registers comprises less than the entire control/status registers; and
a corresponding control channel coupling each execution domain with the isolation domain, each corresponding control channel configured to provide one or more of interrupt routing, reset control, and address space control, wherein each corresponding control channel is configured exclusively by the isolation domain.

2. The processor of claim 1, wherein the address space control of the corresponding control channel is configured to provide access to a region of memory in the physical address space to an execution domain of the one or more execution domains.

3. The processor of claim 1, wherein the interrupt routing of the corresponding control channel is configured to provide a subset of external interrupts to an execution domain of the one or more execution domains.

4. The processor of claim 1, wherein the corresponding control channel is configured to reset an execution domain of the one or more execution domains, without requiring reset of any other execution domains of the one or more execution domains, by applying a reset vector to the execution domain using the reset control of the corresponding control channel.

5. The processor of claim 1, wherein
the one or more execution domains are configured to communicate a service request to the isolation domain by generating an event to activate the highest priority hardware thread, and
the highest priority hardware thread is configured to respond to the service request.

6. The processor of claim 5, wherein
the service request comprises one of an environment call (ECALL) instruction when the processor comprises a RISC-V processor or a system call instruction equivalent to the ECALL instruction when the processor comprises a type of processor other than a RISC-V processor.

7. The processor of claim 5, wherein the service request comprises a custom service request instruction.

8. The processor of claim 5, wherein the service request comprises one or more inter-context communication flag bits.

9. The processor of claim 1, wherein the isolation domain is configured to control which of the one or more execution domain threads executes by the processor.

10. The processor of claim 9, wherein the isolation domain is configured to select which of the one or more execution domain threads is executed by the processor using a round-robin context switching determined by one of a time period or a set number of instructions.

11. A method for handling a service request in a switch-on-event multithreading (SOEMT) processor, the method comprising:
generating, by an execution thread operating at a first priority level, an event comprising the service request;
receiving the event by an isolation thread operating at a second priority level, wherein the second priority level is higher than the first priority level;
preempting the execution thread by the isolation thread;
while the execution thread is being preempted:
executing the service call by the isolation thread, and
providing, by the isolation thread, information responsive to the service call to the execution thread; and
after the providing the information, performing a wait for event by the isolation thread to inactivate the isolation thread.

12. The method of claim 11, wherein the service request is associated with secure system resources accessible to the isolation thread and not accessible to the execution thread.

13. The method of claim 12, wherein the secure system resources comprise at least one of a boot ROM, memory, timer registers, and flash memory.

14. The method of claim 11, wherein the service request is associated with a request to change a subset of physical address space accessible to the execution thread.

15. The method of claim 11, wherein the service request is associated with a request to access one or more of a peripheral and an interrupt generated by the peripheral.

16. The method of claim 11 further comprising:
waiting for an event, by the isolation thread, prior to said receiving the event; and
in response to the receiving the event, activating the isolation thread, wherein activating the isolation thread results in preempting the execution thread.

17. The method of claim 16 further comprising:
after the isolation thread is inactivated, resuming the execution thread.

18. The method of claim 16 wherein the activating the isolation thread comprises activating the isolation thread at an address location which is only accessible by the isolation thread and is not accessible by the execution thread.

19. The method of claim 11, wherein
the processor comprises a RISC-V processor, and
the event comprises an environment call instruction.

20. A system configured to provide isolation of software executing in one or more execution domains, the system comprising:
a processor comprising:
an isolation domain comprising a highest priority hardware thread executed by the processor and configured to access the entire physical address space of the processor, access all control/status registers, all hardware configuration registers, and secure system resources,
one or more execution domains, wherein:
each execution domain comprises a thread executed by the processor with a lower priority than the highest priority hardware thread of the isolation domain,
each execution domain is configured to access an assigned subset of the physical address space and access an assigned subset of the control/status registers but is unable to access any of the secure system resources,
each assigned subset of the physical address space comprises less than the entire physical address space, and
each assigned subset of the control/status registers comprises less than the entire control/status registers, and
a corresponding control channel, coupling each execution domain with the isolation domain, each corresponding control channel configured to provide one or more of interrupt routing, a reset control, and an address space control, wherein each corresponding control channel is configured by the isolation domain;
a memory coupled to the processor; and
a peripheral coupled to the processor, wherein the peripheral is accessible only to the isolation domain.
